(19) United States
(12) Patent Application Publication
(10) Pub. No.: US 2024/0373821 A1
(43) Pub. Date: Nov. 14, 2024

(54) INTERACTIVE BALL PUZZLE AND TREAT MAZE FOR PETS

(71) Applicant: The Kyjen Company, LLC, Centennial, CO (US)

(72) Inventor: Graham Geil Wilson, Denver, CO (US)

(21) Appl. No.: 18/195,187

(22) Filed: May 9, 2023

(51) Int. Cl. A01K 5/02; A01K 5/01; A01K 15/02

(52) U.S. Cl. CPC A01K 5/0233; A01K 5/0114; A01K 15/025

(57) ABSTRACT

A pet toy includes a hollow shell including an internal cavity and a planar opening defining a boundary between the internal cavity of the shell and an exterior of the shell, a hollow retaining member disposed in the internal cavity of the shell, the retaining member including a passage extending from a first aperture disposed on a first side of the retaining member to a second aperture disposed on a second side of the retaining member, the second side opposite the first side, and a hollow treat container disposed in the passage, the treat container including an internal chamber and a hole disposed on an exterior surface of the treat container, such that the chamber is in communication with an exterior of the treat container.

### BACKGROUND OF THE DISCLOSURE

### Field of the Disclosure

The disclosure relates generally to pet toys, and more specifically, to an interactive pet toy configured to dispense treats.

### Brief Description of Related Technology

Generally, a wide variety of pet toys are available to keep pets entertained. For example, pet toys include chew toys which are typically comprised of durable materials such as rubber or nylon and are designed to withstand heavy chewing. Other pet toys include squeaky toys, designed to make noise entertaining pets; balls and frisbees, designed to entertain pets while encouraging exercise; plush toys; and the like. However, in addition to keeping pets entertained, it is important to provide pets with mental stimulus in order to improve their overall health and behavior. Accordingly, there is a need for interactive pet toys that mentally stimulate pets by requiring them to solve a puzzle. Additionally, there is a need for interactive pet toys that reward a pet for successfully completing a puzzle encouraging the pet to engage with the toy again in the future.

### SUMMARY OF THE DISCLOSURE

In accordance with one aspect of the present disclosure, a pet toy includes a hollow shell having an internal cavity. The hollow shell includes a planar opening defining a boundary between the internal cavity of the shell and an exterior of the shell. The pet toy further includes a hollow retaining member disposed in the internal cavity of the shell. The retaining member includes a passage extending from a first aperture disposed on a first side of the retaining member to a second aperture disposed on a second side of the retaining member, the second side opposite the first side. The pet toy further includes a hollow treat container disposed in the passage. The hollow treat container includes an internal chamber and a hole disposed on an exterior surface of the treat container, such that the chamber is in communication with an exterior of the treat container.

In accordance with another aspect of the present disclosure, a pet toy includes a hollow, spherical shell including an internal cavity and a planar, circular opening defining a boundary between the internal cavity of the shell and an exterior of the shell. The pet toy further includes a hollow, spherical segment disposed in the internal cavity of the shell. The spherical segment includes a passage extending from a first aperture disposed on a first planar side of the spherical segment to a second aperture disposed on a second planar side of the spherical segment, the second planar side opposite the first planar side. The pet toy further includes a hollow treat ball disposed in the passage, The hollow treat ball includes an internal chamber and a hole disposed on an exterior surface of the treat ball, such that the chamber is in communication with an exterior of the treat ball.

In accordance with yet another aspect of the present disclosure a method of manufacturing a pet toy includes welding a first half of a hollow retaining member and a second half of a hollow retaining member together to form the hollow retaining member. The hollow retaining member includes a passage extending from first aperture disposed on a first side of the of the hollow retaining member to a second aperture disposed on a second side of the hollow retaining member, the second side opposite the first side. The method further includes welding a first half of a hollow treat container including a hole and a second half of a hollow treat container together to form the hollow treat container. The hollow treat container includes an internal chamber and an exterior surface. The hole is disposed on the exterior surface such that the chamber is in communication with the exterior of the treat container. The method further includes welding a first half of a hollow shell including an opening and a second half of the hollow shell together to form the hollow shell. The hollow shell includes an internal cavity and the opening defines a boundary between the internal cavity of the shell and an exterior of the shell.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 illustrates a perspective view of a pet toy in accordance with one example of the present disclosure.

FIG. 2 illustrates a perspective view of the isolated components of a pet toy in accordance with one example of the present disclosure.

FIG. 3 illustrates a transparent front view of a pet toy in accordance with one example of the present disclosure.

FIG. 4 illustrates a transparent side view of a pet toy in accordance with one example of the present disclosure.

FIG. 5 illustrates a section view A-A taken along the section line A of FIG. 4 in accordance with one example of the present disclosure.

FIG. 6 illustrates a treat container of a pet toy in accordance with one example of the present disclosure.

FIG. 7 illustrates a flow chart for a method of manufacturing a pet toy in accordance with one example of the present disclosure.

While the disclosed pet toys and methods are susceptible of embodiments in various forms, there are illustrated in the drawing (and will hereafter be described) specific embodiments of the disclosure, with the understanding that the disclosure is intended to be illustrative and is not intended to limit the disclosure to the specific embodiments described and illustrated herein.

### DETAILED DESCRIPTION OF THE DISCLOSURE

The present disclosure is provided to solve the above-mentioned problems in the Background of the Disclosure section. Specifically, the present disclosure provides a pet toy that mentally stimulates pets by providing a puzzle to be solved and rewards pets with treats upon completion of the puzzle. As described herein, a pet toy includes a hollow shell having an opening, a retaining member including a passage and an aperture disposed at each end of the passage, and a treat container. The pet toy according to the present disclosure may begin in a nested position in which the treat container is disposed or nested in the passage of the retaining member and the retaining member is disposed or nested in the shell. The toy presents pets with a puzzle or challenge, as the treat container may only be removed from the shell and the retaining member when an aperture of the passage is aligned with the opening in the shell. Accordingly, a pet must manipulate or move the shell and/or retaining members to align an aperture with the opening, allowing the treat container to move outside the shell and retaining member. After the treat container has moved outside the shell and retaining member, the pet may have access to the treats in the treat container, thus rewarding them for solving the puzzle.

Referring generally to the Figures, a pet toy according to the present disclosure may include a hollow shell, a hollow retaining member, and a hollow treat container. The retaining member may be nested in the shell and the treat container may be nested in the retaining member. Each of the retaining member and the treat container may be free to move (e.g., rotate, translate) when they are nested in the shell or the retaining member, respectively. The retaining member may be free to rotate such that an aperture in the retaining member and an opening in the shell align, allowing the treat container to move out of the retaining member and the shell. Specifically, when an aperture of the retaining member and the opening in the shell align, the treat container may be free to move from a nested position inside the shell and the retaining member to a position outside of the shell and the retaining member.

The hollow treat container may include an internal chamber and a hole, the internal chamber being in communication with an exterior of the treat container via the hole. The treat container may be configured to store food or treats for pets. A pet toy in accordance with the present disclosure may be configured to be manipulated or played with by a pet or other animal. In some examples, the pet toy may be configured to be manipulated such that an aperture of the retaining member aligns with the opening of the shell allowing the treat container to move to an exterior of the shell and the retaining member. After the treat container has moved to an exterior of the retaining member and the shell, the treat container alone may be manipulated so that food or treats in the internal chamber of the treat container move through the hole in the treat container to an exterior of the treat container and thus are available to the pet. In some examples, a treat or treats disposed in the treat container may not be accessible until a pet has removed the treat container from inside the retaining member and the shell. For example, a large treat may not be free to move to an exterior of the treat container until after the treat container has been removed from the retaining member and the shell. In some examples, as the pet toy is manipulated or played with, food or treats may move from the internal chamber of the treat container through the hole of the treat container to an exterior of the treat container. When the treat container is nested in the retaining member and shell, after exiting the internal chamber of the treat container, the food or treats may still be trapped between the treat container, the retaining member, and/or the shell. Accordingly, additional manipulation of the pet toy may be required to make the food or treats exit the pet toy through an opening in the shell of the pet toy.

A pet toy in accordance with the present disclosure may be configured to entertain a pet for a duration of time while the pet attempts to get food or treats out of the treat container. A pet may manipulate the pet toy attempting to get food or treats out of the pet toy using, for example, their paws and/or mouth. As the pet manipulates the pet toy, the retaining member and/or treat container may move within the shell. A pet may manipulate the pet toy attempting to align an aperture of the retaining member with the opening of the shell, so as to remove the treat container from the shell. In some examples, food or treats may exit the pet toy before the treat container is removed from the pet toy. However, when the treat container is on the exterior of the shell, it may be easier to get food or treats out of the container than when the treat container is nested in the shell.

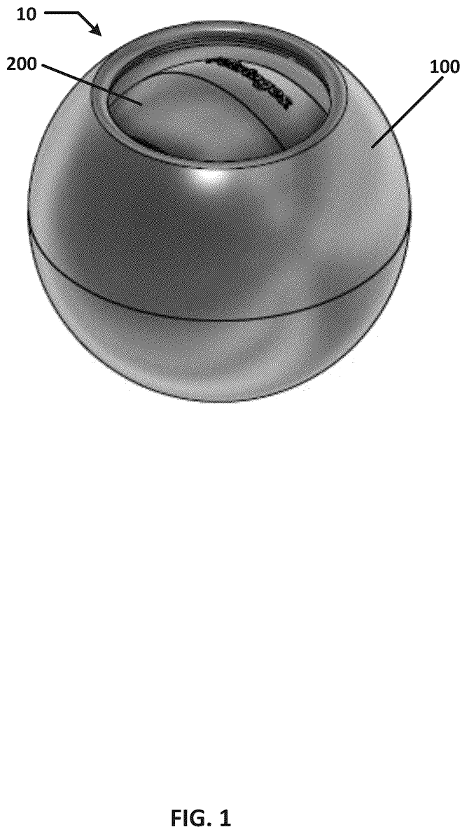

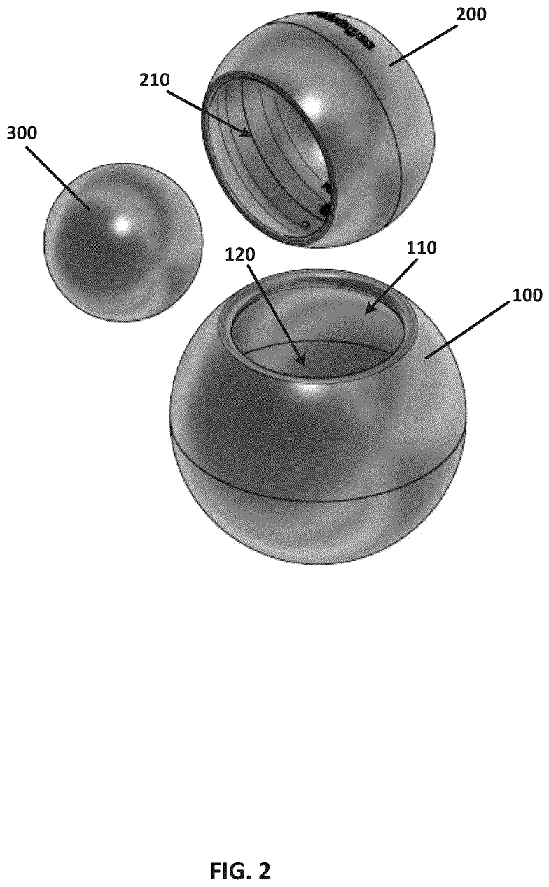

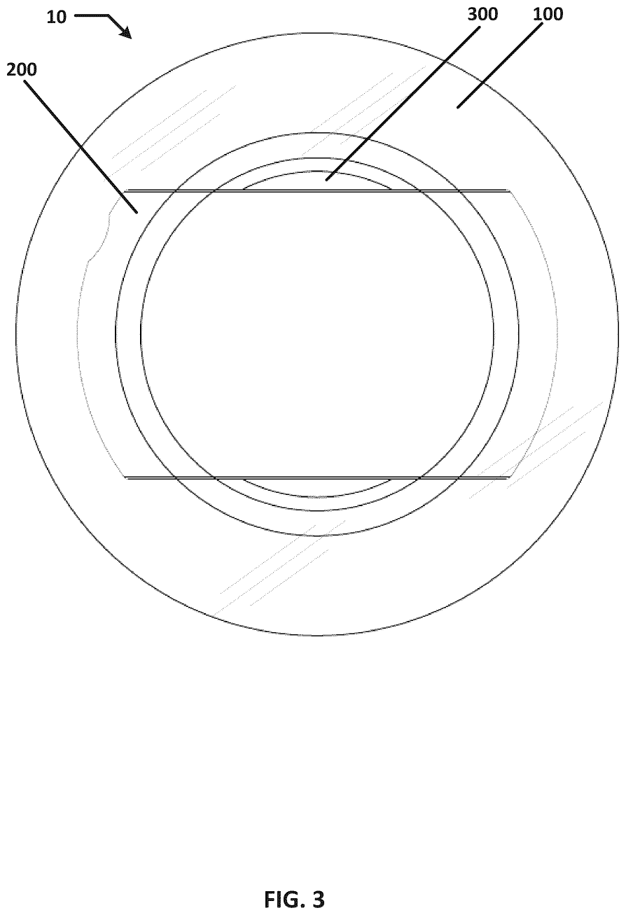

Referring generally to FIGS. 1-6, a pet toy in accordance with one example of the present disclosure is illustrated. FIG. 1 illustrates a pet toy 10 in a nested state in which a treat container 300 (not shown in FIG. 1) is nested in a retaining member 200 (see FIGS. 3-5) and the retaining member 200 is nested in a shell 100. FIG. 2 illustrates the isolated individual components of the pet toy 10. Specifically, FIG. 2 illustrates an isolated hollow shell 100, hollow retaining member 200, and treat container 300. One or more of the shell 100, retaining member 200, and treat container 300 may be comprised of a thermoplastic elastomer (TPE). For example, one or more of the shell 100, retaining member 200, and treat container 300 may be comprised of styrenic block copolymers, thermoplastic polyolefinelastomers, thermoplastic vulcanizates, thermoplastic polyurethanes, thermoplastic copolyester, thermoplastic polyamides, or the like. In other examples, one or more of the shell 100, retaining member 200, and treat container 300 may be comprised of thermoplastic rubber (TPR), thermoplastic polyurethane (TPU), polyvinyl chloride (PVC), rubber, polypropylene (PP), acrylonitrile butadiene styrene (ABS), low density polyethylene (LDPE), or high density polyethylene (HDPE). Other suitable materials, now known or later developed, may also be used.

In some examples, one or more of the shell 100, retaining member 200, and treat container 300 may be transparent. Specifically, in some examples, the shell 100 may be transparent. A transparent shell 100 may allow a pet to see into the pet toy 10 to determine a position or orientation of the retaining member 200 and/or treat container 300. In some examples, the shell 100, retaining member 200, and treat container 300 may be different colors. Specifically, the shell 100, retaining member 200, and treat container 300 may be different bright colors so as to be visible to pets having a limited visible color spectrum.

Referring to FIG. 2, the shell 100 may include an opening 110 defining a boundary between an internal cavity 120 and an exterior of the shell 100. As illustrated in FIG. 1, the retaining member 200 may be disposed or nested in the internal cavity 120 of the shell 100. The retaining member 200 may be nested in the shell 100 such that the retaining member 200 is free to move (e.g., rotate, translate) within an internal cavity 120 of the shell 100. The retaining member 200 may be larger than the opening 110 in the shell 100 such that the retaining member 200 is maintained within the shell 100 as the retaining member moves within the internal cavity 120 of the shell 100. Specifically, when the retaining member 200 is a spherical segment and the opening 110 is circular, a diameter of the retaining member 200 may be larger than a diameter of the opening 110, such that the retaining member 200 cannot pass through the opening 110.

Referring to FIG. 2, the retaining member 200 may include a passage 210 extending from an aperture disposed on a first side of the retaining member 200 to an aperture disposed on a second, opposite side of the retaining member 200. The treat container 300 may be disposed or nested within the passage 210 of the retaining member 200. The treat container 300 may be nested in the retaining member 200, such that the treat container 300 is free to move (e.g., rotate, translate) within the passage 210 of the retaining member 200.

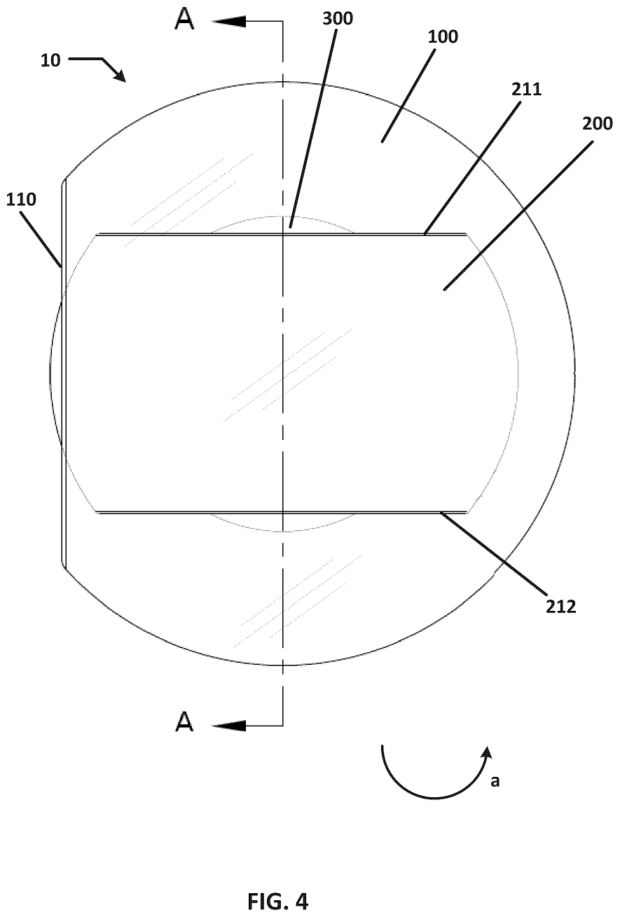

FIG. 3 illustrates a transparent, front view and FIG. 4 illustrates a transparent, side view of the pet toy 10 in accordance with one example of the present disclosure. As illustrated in FIGS. 3 and 4, the pet toy 10 is in a nested state in which the treat container 300 is disposed or nested inside the retaining member 200 and the retaining member 200 is disposed or nested inside the shell 100. As illustrated in FIGS. 3 and 4, the treat container 300 may be smaller than the passage 210 of the retaining member 200 and the opening 110 of the shell 100. The treat container 300 may be smaller than the passage 210 and the opening 110 so as to be able to freely move through the passage 210 of the retaining member 200 and then the opening 110 of the shell 100. Specifically, the cross-sectional area of at least one side of the treat container 300 may be smaller than a cross-sectional area of the passage 210 of the retaining member and the opening 110 of the shell 100, such that the treat container 300 may move through the passage 210 of the retaining member 200 and then the opening 110 of the shell 100. Specifically, referring to FIGS. 3 and 4, the treat container 300 has a circular cross-sectional area that is smaller than a circular cross-sectional area of the passage 210 of the retaining member 200 and the opening 110 of the shell such that the treat container 300 is able to move through the retaining member and then the opening 110. However, as described below, the present disclosure is not limited there to and the shape and size of the treat container 300, passage 219 and opening 110 may vary.

However, as illustrated in FIGS. 3 and 4, in some positions, the retaining member 200 may be oriented such that the opening 110 or a portion of the opening 110 is blocked by the retaining member 200. When the opening 110 or a portion of the opening 110 is blocked by the retaining member 200, the retaining member 200 may block or prevent the treat container 300 from moving or passing through the opening 110. Accordingly, the retaining member 200 may need to be manipulated or moved so as to not block the opening 110, allowing the treat container 300 to move or pass through the passage 210 and the opening 110. Orientations of the retaining member 200 that do not block the opening 110 are described below in greater detail.

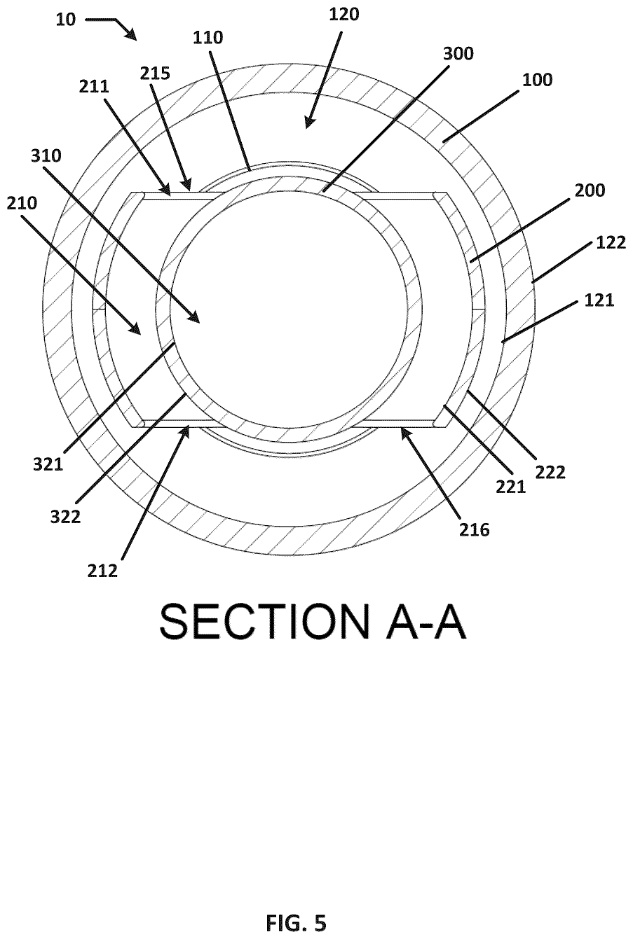

Referring to FIG. 5, section view A-A taken along section line A of FIG. 4 is illustrated. The section view of FIG. 5 includes the hollow shell 100, the retaining member 200, and the treat container 300. The hollow shell 100 includes an opening 110 defining a boundary between an internal cavity 120 of the shell 100 and an exterior of the shell (see FIG. 2). As illustrated in FIG. 5, the shell further includes a shell interior surface 121 and a shell exterior surface 122. The opening 110 and shell interior surface 121, collectively, may define the internal cavity 120 of the shell 100.

As illustrated in FIGS. 2 and 5, the shell 100 has a hollow spherical shape including a planar circular opening 110 defining a boundary between the internal cavity 120 of the shell and an exterior of the shell. However, the present disclosure is not limited thereto. Specifically, the size and shape of the shell 100 and the opening 110 may vary. For example, the shell 100 may have a hollow spheroid shape, a hollow cuboid shape, a hollow pyramid shape, a hollow cylindrical shape, a hollow conical shape, or the like. Additionally, in some examples, the opening 110 may have an elliptic shape, a triangular shape, a rectangular shape, a square shape, a polygon shape, or the like. In some examples, the shape of the opening 110 may correspond to the shape of a face or side of shell 100. For example, a cuboid shell may include a square shaped opening. In some examples, the shape of the opening 110 may correspond to the shape of a profile of the treat container 300. For example, when the treat container 300 has a spherical shape, the opening 110 may be circular. In another example, when the treat container 300 has a cuboid shape, the opening 110 may be rectangular or square-shaped.

As illustrated in FIG. 5, the retaining member 200 is disposed in the internal cavity 120 of the shell 100. In some examples, the retaining member 200 may be disposed within the internal cavity 120 of the shell 100 so as to have the same center or be concentric with the shell 100. The retaining member 200 may be smaller than the internal cavity 120 so as to fit within the internal cavity 120 and be free to move within the internal cavity 120. For example, as illustrated in FIG. 5, the retaining member 200 is a spherical segment having a smaller volume than the spherical internal cavity 120 of the shell 100. However, as described below, the present disclosure is not limited thereto.

The retaining member 200 includes a passage 210 extending from a first aperture 211 disposed on a first side 215 of the retaining member 200 to a second aperture 212 disposed on a second side 216 of the retaining member 200. In some examples, the first and second sides 215, 216 and/or first and second apertures 211, 212, respectively, may be opposite one another. The retaining member 200 may include a retaining member interior surface 221. The retaining member interior surface 221, first aperture 211, and second aperture 212, collectively, may define the passage 210 of the retaining member 200. As illustrated in FIGS. 2 and 5, the passage 210 has the shape of a spherical segment, or spherical frustum. Specifically, as illustrated in FIGS. 2 and 5, the passage 210 has the shape of a spherical segment, truncated on two opposite sides. However, the present disclosure is not limited thereto. For example, the passage 210 may have a cuboid shape, a pyramid shape, a cylindrical shape, a conical shape, or the like. In some examples, the shape of the passage 210 may correspond to the shape of the treat container 300. For example, when the treat container has a hollow spherical shape, the passage 210 may have the shape of a spherical segment or a cylinder, such as that shown in FIGS. 2-6. In another example, when the treat container 300 has a cuboid shape, the passage 210 may have the shape of a rectangle or cube.

Additionally, the shape of the first aperture 211 and the second aperture 212 may vary. For example, the first aperture 211 and/or second aperture 212 may have an elliptic shape, a triangle shape, a rectangular shape, a square shape, a polygon shape, or the like. In some examples, the shape of the first aperture 211 or the second aperture 212 may correspond to the shape of a face of the retaining member 200. For example, a cuboid retaining member 200 may include a square shaped first aperture 211 and/or second aperture 212. In some examples, the retaining member 200 may only include one aperture (e.g., first aperture 211).

The retaining member 200 may further include a retaining member exterior surface 222 opposite the retaining member interior surface 221. In some examples, the retaining member interior surface 221 and/or the retaining member exterior surface 222 may be curved surfaces. For example, as illustrated in FIG. 5, the retaining member may have a generally convex shape. Specifically, the retaining member interior surface 221 may have a convex shape, with a middle of the of the retaining member interior surface 221 curving away from a center of the retaining member 200. Further, as illustrated in FIG. 5, the retaining member exterior surface 222 may also have a convex shape, with a middle of the retaining member exterior surface 222 curving away from a center of the retaining member 200. However, the present disclosure is not limited thereto, for example, the retaining member interior surface 221 and/or the retaining member exterior surface 222 may be linear surfaces. In some examples, the retaining member interior surface 221 and the retaining member exterior surface 222 may be curved surfaces with a center of the retaining member interior surface 221 and/or a center of the retaining member exterior surface 222, respectively, curving toward a center of the retaining member 200.

As illustrated in FIGS. 2 and 5, the retaining member 200 has the shape of a hollow, spherical segment. However, the present disclosure is not limited thereto. Specifically, the size and shape of the retaining member 200 may vary. For example, the retaining member 200 may have a hollow spheroid shape, a hollow cuboid shape, a hollow pyramid shape, a hollow cylindrical shape, a hollow conical shape, or the like.

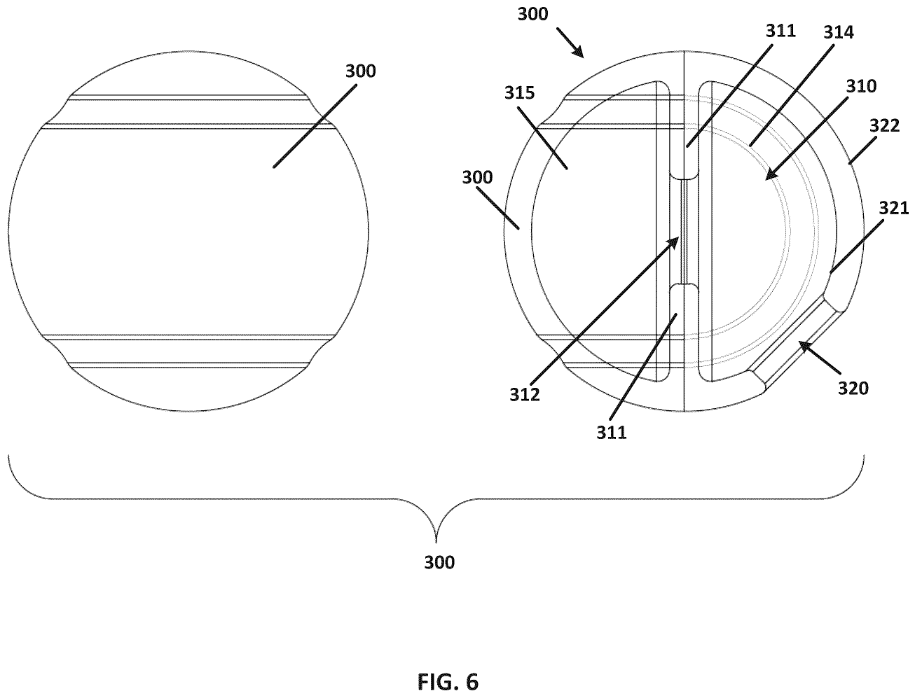

Referring to FIG. 6, a treat container 300 in accordance with one example of the present disclosure is illustrated. As illustrated in FIG. 6, the treat container 300 includes an internal chamber 310 and a hole 320 defining a boundary between the internal chamber 310 and an exterior of the treat container 300. The treat container 300 further includes a container inner surface 321 and a container exterior surface 322 opposite the container inner surface 321. The container inner surface 321 and the hole 320, collectively, may define the internal chamber 310.

In some examples, the treat container 300 may further include one or more internal walls 311, dividing the internal chamber 310 into a plurality of chambers, for example first chamber 314 and second chamber 315. In some examples, the plurality of chambers 314, 315 may be the same size. In other examples, one of the plurality of chambers (e.g., a first chamber) may be larger than another of the plurality of chambers (e.g., a second chamber). A channel 312 may connect two or more of the plurality of chambers, such that pet food or treats may freely pass between the chambers through the channel 312.

As illustrated in FIG. 6, the treat container 300 has a hollow, spherical shape. A treat container 300 having a hollow, spherical shape may be referred to herein as a treat ball. However, the present disclosure is not limited thereto. Specifically, the size and shape of the treat container 300 may vary. For example, the treat container 300 may have a hollow spheroid shape, a hollow cuboid shape, a hollow pyramid shape, a hollow cylindrical shape, a hollow conical shape, or the like. Additionally, the size and shape of the hole 320 may vary. For example, the hole 320 may have an elliptic shape, a triangular shape, a rectangular shape, a square shape, a polygon shape, or the like.

Returning to FIG. 5, the treat container 300 may be disposed (at least partially) within the passage 210 of the retaining member 200. In some examples, the treat container 300 may be disposed within the passage 210 so as to have the same center or be concentric with the retaining member 200 and/or the shell 100. The treat container 300 may be smaller than the passage 210 so as to fit within the passage 210 and be free to move within the passage 210. For example, the treat container 300 may have a hollow spherical shape and the passage 210 may have the shape of a spherical segment, with the treat container 300 having a smaller volume than the spherical segment such that the treat container 300 is free to move within the passage 210. Additionally, the treat container 300 may be smaller than the first aperture 211 and the second aperture 212 such that the treat container may pass through the first aperture 211 and the second aperture 212. For example, the first aperture 211 and the second aperture 212 may have a circular shape and the treat container 300 may have a circular cross-sectional shape, with the treat container 300 having a largest cross-sectional area smaller than the first aperture 211 and the second aperture 212. In some examples, the shape of the first aperture 211, the second aperture 212, and/or the opening 110 may have a shape corresponding the shape of a face or side of the treat container 300. For example, when the treat container 300 has a spherical shape, the first aperture 211, second aperture 212, and/or opening 110 may have a circular shape. In another example, when the treat container 300 has a cuboid shape, the first aperture 211, second aperture 212, and/or opening 110 may have a rectangular or square shape.

Returning back to FIG. 4, the retaining member 200 may be free to move within the internal cavity 120 of the shell 100. Accordingly, a position or orientation of the retaining member 200, for example, with respect to the shell 100 may be changed or altered. Specifically, an orientation of the retaining member 200 may be changed such that the first aperture 211 and/or the second aperture 212 align with the opening 110 of the shell 100. Specifically, referring to FIG. 4, the retaining member 200 may be rotated from the position illustrated in FIG. 4, in which one side of the retaining member 200 blocks the opening 110 in the shell, ninety degrees in the direction of arrow a such that the first aperture 211 of the retaining member 200 aligns with the opening 110 of the shell 100. When the first aperture 211 or the second aperture 212 of the retaining member 200 aligns with the opening 110 of the shell 100, the treat container 300 may be free to move through the first aperture 211 or the second aperture 212 and through the opening 110 of the shell 100 to an exterior of the shell 100. When the treat container 300 is disposed outside of the shell 100 it may be easier, relative to when the treat container 300 is disposed within the retaining member 200 and the shell 100, to get food or treats out of the treat container 300 (or to refill the treat container 300).

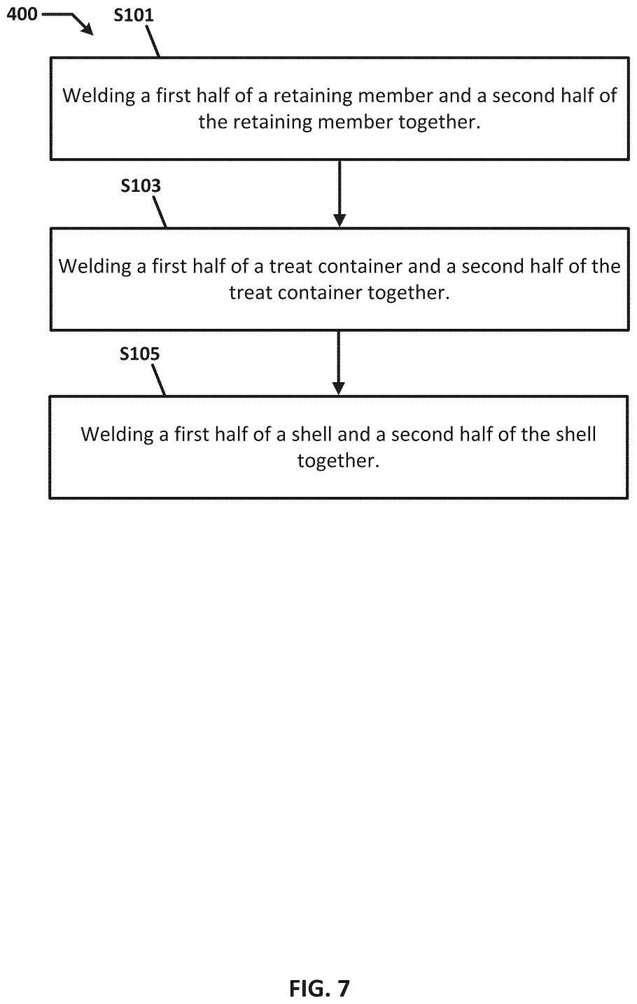

Referring to FIG. 7, a flowchart 400 for manufacturing a pet toy in accordance with one example of the present disclosure is illustrated. The flowchart 400 may be used to manufacture, for example, the pet toy 10 described above. Different, fewer, or additional acts may be provided. The flowchart for manufacturing a pet toy may be implemented in the order shown but may be implemented in or according to any number of different orders. For example, welding a first half of a treat container and a second half of the treat container together (act S103) may be performed before welding a first half of a retaining member and a second half of a retaining member together (act S101)

In a first act S101, a first half of a hollow retaining member and a second half of the hollow retaining member may be welded together to form a hollow retaining member. The hollow retaining member may be the same as the retaining member 200 described above. As described above, the hollow retaining member may include a passage extending from a first aperture disposed on first side of the retaining member to a second aperture disposed on a second side of the retaining member. It should be noted that while the terms “first half” and “second half” are used, the first half of the hollow retaining member and the second half of the hollow retaining member, respectively, may not be exactly fifty percent of the hollow retaining member and may comprise more or less than fifty percent of the hollow retaining member, respectively.

In some examples, the first half of the hollow retaining member and the second half of the hollow retaining member may have the same shape. For example, when the hollow retaining member has the shape of a spherical segment, as illustrated in FIG. 2, both the first half and the second half of the retaining member may have the same annular or ring shape. In another example, when the retaining member has a hollow cylindrical shape, both the first half and the second half of the hollow retaining member may have the same hollow cylindrical shape.

In a second act S103, a first half of a hollow treat container and a second half of the hollow treat container may be welded together to form the hollow treat container. The hollow treat container may be the same as the treat container 300 described above. In some examples, the hollow treat container may be a treat ball. The first half of the hollow treat container may include a hole. As described above, the treat container may include an internal chamber and an exterior surface. The hole in the first half of the hollow treat container may be disposed on the exterior surface of the treat container such that the internal chamber is in communication with the exterior of the treat container via the hole.

It should be noted that while the terms “first half” and “second half” are used, the first half of the treat container and the second half of the treat container, respectively, may not be exactly fifty percent of the treat container and may comprise more or less than fifty percent of the treat container, respectively. In some examples, the first half of the hollow treat container and the second half of the hollow treat container may have a the same or a substantially similar shape. For example, when the hollow treat container is a treat ball, the treat container first half and the treat container second half may both have a hemisphere shape. However, the present disclosure is not limited thereto, and the first half and second half of the treat container may have different shapes, respectively. As described above, only the first half of the treat container includes a hole; however, in some examples, both the first half of the treat container and the second half of the treat container may include a hole such that the internal chamber is in communication with the exterior of the treat container via the hole. Additionally, in some examples, the treat container first half and/or the treat container second half may include two or more holes.

In a third act S105, a first half of a hollow shell and a second half of the shell are welded together to form the hollow shell. The hollow shell may be the same as the hollow shell 100 described above. In some examples, the first half of the hollow shell may include an opening. As described above, the shell may include an internal cavity and an opening formed in the first half of the shell may define a boundary between the internal cavity of the shell and an exterior of the shell.

It should be noted that while the terms “first half” and “second half” are used, the first half of the shell and the second half of the shell, respectively, may not be exactly fifty percent of the shell and may comprise more or less than fifty percent of the shell, respectively. In some examples, the first half of the hollow shell and the second half of the hollow shell may have a the same or a substantially similar shape. For example, when the shell has a hollow, spherical shape the first half of the shell and the second half of the shell may both have a hemisphere shape. However, the present disclosure is not limited thereto, and the first half and second half of the shell may have different shapes, respectively. As described above, only the first half of shell may include an opening. However, the present disclosure is not limited thereto, and, in some examples, both the first half of the shell and the second half of the shell may include an opening such that the internal cavity is in communication with the exterior of the shell via the openings. Additionally, in some examples, the shell first half and/or the shell second half may include two or more openings.

In some examples, the first half of the shell and the second half of the shell may be welded together so as to include the hollow retaining member within the internal cavity of the shell. In some examples, as described above, the retaining member may be larger than the opening in the shell such that the retaining member cannot pass through the opening in the shell. Accordingly, the first half of the shell and the second half of the shell may be welded together so as to include the retaining member withing the internal cavity of the shell so as to achieve the nested position of the retaining member within the shell.

In some examples, the welding a first half of the hollow retaining member and a second half of the hollow retaining member together, the welding a first half of the hollow treat container and a second half of the hollow treat container together, and/or the welding a first half of a hollow shell and a second half of a hollow shell together may comprise sonic or ultrasonic welding. Specifically, ultrasonic welding in which high-frequency mechanical vibrations are used to generate friction induced heat at an interface between elements to be joined, resulting in melting of thermoplastic materials and weld formation after cooling may be used to join two or more components of the pet toy 10.

In other examples, the welding a first half of the hollow retaining member and a second half of the hollow retaining member together, the welding a first half of the hollow treat container and a second half of the hollow treat container together, and/or the welding a first half of a hollow shell and a second half of a hollow shell together may comprise heat welding. In these examples, heat may be applied directly or indirectly to an interface between elements to be joined, causing melting of thermoplastic materials and weld formation after cooling. In some examples, a heat gun may be used during heat welding.

In some examples, the first half of the hollow retaining member and the second half of the hollow retaining member, the first half of the hollow treat container and the second half of the hollow treat container, and/or the first half of the hollow shell and the second half of the hollow shell, respectively, may not be welded together, but instead may be joined together using an adhesive or glue.

While the present disclosure has been described with reference to specific examples, which are intended to be illustrative only and not to be limiting of the disclosure, it will be apparent to those of ordinary skill in the art that changes, additions and/or deletions may be made to the disclosed embodiments without departing from the spirit and scope of the disclosure.

The foregoing description is given for clarity of understanding only, and no unnecessary limitations should be understood therefrom, as modifications within the scope of the disclosure may be apparent to those having ordinary skill in the art.

When a component, device, element, or the like of the present disclosure is described as having a purpose or performing an operation, function, or the like, the component, device, or element, should be considered herein as being “configured to” meet that purpose or perform that operation or function.

1. A pet toy comprising:
a hollow shell including an internal cavity and a planar opening defining a boundary between the internal cavity of the shell and an exterior of the shell;
a hollow retaining member disposed in the internal cavity of the shell, the retaining member including a passage extending from a first aperture disposed on a first side of the retaining member to a second aperture disposed on a second side of the retaining member, the second side opposite the first side; and
a hollow treat container disposed in the passage, the treat container including an internal chamber and a hole disposed on an exterior surface of the treat container, such that the chamber is in communication with an exterior of the treat container.

2. The pet toy of claim 1, wherein:
the hollow retaining member is free to move within the internal cavity;
the treat container is free to move within the passage; and
when the first aperture or the second aperture of the hollow retaining member aligns with the opening of the shell, the treat container is free to move to the exterior of the shell.

3. The pet toy of claim 1, wherein at least two of the shell, the retaining member, and the treat container are concentric.

4. The pet toy of claim 1, wherein a shape of the opening corresponds to a profile of the treat container.

5. The pet toy of claim 1, wherein a shape of the passage corresponds to a shape of the treat container.

6. The pet toy of claim 1, wherein the shell, the retaining member, and the treat container have on of a spheroid shape, a cuboid shape, a pyramid shape, cylindrical shape, and cone shape.

7. The pet toy of claim 1, wherein the chamber includes a plurality of chambers in communication with each other.

8. The pet toy of claim 1, wherein one of the shell, the retaining member, and the treat container are comprised of a thermoplastic elastomer.

9. A pet toy comprising:
a hollow, spherical shell including an internal cavity and a planar, circular opening defining a boundary between the internal cavity of the shell and an exterior of the shell;
a hollow, spherical segment disposed in the internal cavity of the shell, the spherical segment including a passage extending from a first aperture disposed on a first planar side of the spherical segment to a second aperture disposed on a second planar side of the spherical segment, the second planar side opposite the first planar side; and
a hollow treat ball disposed in the passage, the hollow treat ball including an internal chamber and a hole disposed on an exterior surface of the treat ball, such that the chamber is in communication with an exterior of the treat ball.

10. The pet toy of claim 9, wherein:
the hollow, spherical segment is free to move within the internal cavity;
the treat ball is free to move within the passage; and
when the first aperture or the second aperture of the spherical segment aligns with the opening of the shell, the treat ball is free to move to the exterior of the shell.

11. The pet toy of claim 9, wherein an outer diameter of the hollow spherical segment is larger than a diameter of the opening.

12. The pet toy of claim 9, wherein an inner diameter of the hollow spherical segment is larger than an outer diameter of the treat ball.

13. The pet toy of claim 9, wherein the chamber includes a plurality of chambers in communication with each other.

14. The pet toy of claim 13, wherein a first chamber of the plurality of chambers is larger than a second chamber of the plurality of chambers.

15. The pet toy of claim 9, wherein the shell is translucent.

16. The pet toy of claim 9, wherein one of the shell, spherical segment and treat ball are comprised of a thermoplastic elastomer.

17-20. (canceled)

21. A pet toy comprising:
a hollow shell including an internal cavity and an opening defining a boundary between the internal cavity of the shell and an exterior of the shell; and
a hollow treat container disposed in the internal cavity, the treat container including an internal chamber and a hole disposed on an exterior surface of the treat container, such that the chamber is in communication with an exterior of the treat container.

22. The pet toy of claim 21, wherein the treat container is free to move within the internal cavity.

23. The pet toy of claim 21, wherein the outer shell is translucent.

24. The pet toy of claim 21, wherein the treat container has a spherical shape.
